(19) United States
(12) Patent Application Publication
(10) Pub. No.: US 2023/0204916 A1
(43) Pub. Date: Jun. 29, 2023

(54) PROJECTION LENS AND PROJECTOR

(71) Applicant: IVIEW DISPLAYS (SHENZHEN) COMPANY LTD., Shenzhen (CN)

(72) Inventors: Jiuwei Liang, Shenzhen (CN); Weizhan Zhu, Shenzhen (CN); Mingnei Ding, Shenzhen (CN); Steve Yeung, Hongkong (CN); Zhiqiang Gao, Hongkong (CN)

(21) Appl. No.: 18/080,030

(22) Filed: Dec. 13, 2022

(30) Foreign Application Priority Data
Dec. 23, 2021 (CN) 202111590044.0

(51) Int. Cl. G02B 13/00; G02B 13/16; G02B 9/34; G03B 21/00

(52) U.S. Cl. CPC G02B 13/004; G02B 13/16; G02B 9/34; G02B 13/006; G03B 21/008

(57) ABSTRACT

The present disclosure provides a projection lens and a projector. The projection lens includes: a first lens, a second lens, a third lens, a triple-cemented lens, a fourth lens, a prism, and a DMD chip that are successively disposed along an optical axis from an image side to an object side; wherein the first lens has a negative focal power, the second lens has a negative focal power, the third lens has a positive focal power, the triple-cemented lens has a positive focal power, and the fourth lens has a positive focal power.

### CROSS-REFERENCE TO RELATED APPLICATIONS

This application is a continuation of Chinese Patent Application No. 2021115900440, filed with the Chinese Patent Office on Dec. 23, 2021, and entitled “PROJECTION LENS AND PROJECTOR”, the entire contents of which are incorporated herein by reference.

### TECHNICAL FIELD

Embodiments of the present disclosure relate to the technical field of optics, and in particular, relate to a projector lens and a projector.

### BACKGROUND

With advancements of technologies, more and more people are presentations, videos, or viewing various programs over projectors. For portability and convenient use of the projectors, the size and weight of the projectors need to be reduced.

### SUMMARY

The embodiments of the present disclosure provide a projection lens. The projection lens includes: a first lens, a second lens, a third lens, a triple-cemented lens, a fourth lens, a prism, and a DMD chip that are successively disposed along an optical axis from an image side to an object side; wherein the first lens has a negative focal power, the second lens has a negative focal power, the third lens has a positive focal power, the triple-cemented lens has a positive focal power, and the fourth lens has a positive focal power.

In some embodiments, the DMD chip has a dimension of 0.2 inches.

In some embodiments, the projection lens has a total length of 44 mm, the projection lens has an effective focal length of 5.7 mm, the projection lens has an F-number of 1.7, and the projection lens has a throw ratio of 1.2.

In some embodiments, the projection lens further includes a stop, wherein the stop is disposed between the third lens and the triple-cemented lens.

In some embodiments, the first lens is a first negative meniscus lens, a convex surface of the first negative meniscus lens being proximal to the image side and a concave surface of the first negative meniscus lens being proximal to the object side; and the first lens has a focal length f1 satisfying −18 mm≤f1≤−16 mm; and the second lens is a second negative meniscus lens, a convex surface of the second negative meniscus lens being proximal to the image side and a concave surface of the second negative meniscus lens being proximal to the object side; and the second lens has a focal length f2 satisfying −15 mm≤f2≤−13 mm; the third lens is a planoconvex lens or a first biconvex lens, a convex surface of the planoconvex lens being proximal to the image side; and the third lens has a focal length f3 satisfying 9 mm≤f3≤11 mm; the triple-cemented lens is constructed by cementing a first negative lens, a second negative lens, and a second biconvex lens, wherein the first negative lens has a focal length f4 satisfying −12 mm≤f4 ≤−10 mm, the second negative lens has a focal length f5 satisfying −11 mm≤f5≤−9.5 mm, and the second biconvex lens has a focal length f6 satisfying 9 mm≤f6≤11 mm; and the fourth lens is a third biconvex lens, and the fourth lens has a focal length f7 satisfying 9.8 mm≤f7≤10 mm.

In some embodiments, the first lens has a thickness d1 satisfying 1.2 mm≤d1 ≤1.5 mm; the second lens has a thickness d2 satisfying 1.1 mm≤d2≤1.4 mm; the third lens has a thickness d3 satisfying 2 mm≤d3≤2.5 mm; the first negative lens has a thickness d4 satisfying 2.6 mm≤d4≤2.8 mm; the second negative lens has a thickness d5 satisfying 0.9 mm≤d5≤1.1 mm; the second biconvex lens has a thickness d6 satisfying 4 mm≤d6≤5 mm; and the fourth lens has a thickness d7 satisfying 3.5 mm≤d7≤4.2 mm.

In some embodiments, a distance x1 between a surface, proximal to the object side, of the first lens and a surface, proximal to the image side, of the second lens satisfies 2.7 mm≤x1≤3 mm; and a distance x2 between a surface, proximal to the object side, of the second lens and a surface, proximal to the image side, of the third lens satisfies 3.7 mm≤x2≤4 mm; a distance x3 between a surface, proximal to the object side, of the third lens and the stop satisfies 2.1 mm≤x3≤3.3 mm; and a distance between the stop and a surface, proximal to the image side, of the first biconvex lens is 0.59 mm; a distance x4 between a surface, proximal to the object side, of the second biconvex lens and a surface, proximal to the image side, of the fourth lens satisfies 0.1 mm≤x4≤0.2 mm; and a distance between a surface, proximal to the object side, of the fourth lens and a surface, proximal to the image side, of the prism is 4.27 mm.

In some embodiments, the first lens, the third lens, the first negative lens, the second negative lens, and the second biconvex lens are spheric lenses, and the second lens and the fourth lens are aspheric lenses.

In some embodiments, the projection lens further includes a protective glass, wherein the protective glass is disposed between the prism and the DMD chip.

In a second aspect, the embodiments of the present disclosure further provide a projector. The projector includes the projection lens according to the first aspect.

### BRIEF DESCRIPTION OF THE DRAWINGS

One or more embodiments are illustrated by way of example, and not by limitation, in the figures of the accompanying drawings, wherein elements/modules and steps having the same reference numeral designations represent like elements/modules and steps throughout. The drawings are not to scale, unless otherwise disclosed.

FIG. 1 is a schematic structural diagram of a projection lens according to an embodiment of the present disclosure;

FIG. 2 is a schematic diagram of a range of field of view of the structure in FIG. 1 under an optical axis offset of 0 and an optical axis offset of 100%;

FIG. 3 is a schematic spot diagram of the projection lens in FIG. 1 in a full field of view;

FIG. 4 is a schematic diagram of MTF values of a full field of view of the projection lens illustrated in FIG. 1;

FIG. 5 is a schematic diagram of field curvature and distortion of a full field of view and full wave-band of the projection lens in FIG. 1; and

FIG. 6 is a schematic diagram of vertical chromatic aberration of a full field of view and full wave-band of the projection lens in FIG. 1.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For better understanding of the present disclosure, the present disclosure is described in detail with reference to attached drawings and specific embodiments. Unless the context clearly requires otherwise, throughout the specification and the claims, technical and scientific terms used herein denote the meaning as commonly understood by a person skilled in the art. Additionally, the terms used in the specification of the present disclosure are merely for describing the objects of the specific embodiments, and are not intended to limit the present disclosure. As used herein, the term “and/or” in reference to a list of one or more items covers all of the following interpretations of the term: any of the items in the list, all of the items in the list and any combination of the items in the list.

It should be noted that, in the absence of conflict, embodiments of the present disclosure and features in the embodiments may be incorporated, which all fall within the protection scope of the present disclosure. In addition, although function module division is illustrated in the schematic diagrams of devices, and in some occasions, module division different from the divisions of the modules in the devices may be used. Further, the terms “first,” “second,” and the like used in this text do not limit data and execution sequences, and are intended to distinguish identical items or similar items having substantially the same functions and effects.

The conventional projection lens generally has a small size, and cannot be applicable to small-dimension projection chips.

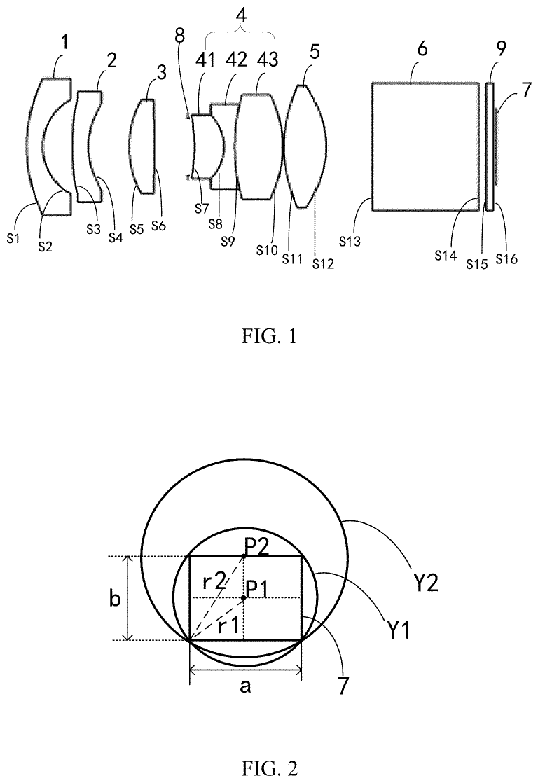

In a first aspect, an embodiment of the present disclosure provides a projection lens. Referring to FIG. 1, the projection lens includes a first lens 1, a second lens 2, a third lens 3, a triple-cemented lens 4, a fourth lens 5, a prism 6, and a DMD chip 7 that are successively disposed along an optical axis from an image side to an object side. The first lens 1 has a negative focal power, the second lens 2 has a negative focal power, the third lens 3 has a positive focal power, the triple-cemented lens 4 has a positive focal power, and the fourth lens 5 has a positive focal power.

In the projection lens, the DMD chip 7 is configured to receive the illumination light and then cause the light with image information to exit to the prism 6. The prism 6 is configured to deflect the light, separate an illumination light path from an imaging light path, for example, causing the light to exit from an illumination unit to the DMD chip 7 and causing the light exiting from the DMD chip 7 to exit to the fourth lens 5. The specific structure of the prism 6 may refer to the structure in the related art, which is not described in detail herein.

The fourth lens 5 is configured to receive the light exiting from the DMD chip 7 and correct an aberration of the light; the triple-cemented lens 4 may be configured to correct a chromatic aberration of the light; the third lens 3 is configured to change a direction of the light; the second lens 2 may be configured to correct part of the monochromatic aberration of the light; and the first lens 1 may be configured to improve a large field of view of the projection lens and meet a requirement of the large field of view of the projection lens. Apparently, the projection lens may correct the chromatic aberration and the aberration, such that a display effect of projected image is improved, and the requirement of the large field of view of the projection lens is met.

In addition, in the projection lens, the first lens 1, the second lens 2, and the third lens 3 constitute a first lens group, and the triple-cemented lens 4 and the fourth lens 5 constitute a second lens group. The first lens group has a negative total focal power such that the field of view of the projection lens is improved, and the second lens group has a positive total focal power such that the aberration, for example, the chromatic aberration, is corrected. The first lens group and the second lens group are combined to form a reverse long-distance lens group, such that a back focal length of the projection lens is greater than a focal length thereof, that is, the back focal length is made longer. In this way, a reserved position may be provided for the prism 6 in the subsequent design process to improve the flexibility of subsequent design. In addition, the projection lens has a small number of lenses and a small size, and is applicable to small-dimension DMD chips.

In some embodiments, the DMD chip has a dimension of 0.2 inches. A pixel size of the DMD chip is 5.4 μm, the maximum number of pixels is 854×480, and a maximum device size is 4.6116×2.592 mm. Therefore, the projection lens is applicable to small-dimension DMD chips, which reduces the size of a projection system and provides a possibility for miniaturized design.

In addition, the projection lens has a lens image height of 7.2 mm, which may achieve a 100% optical axis offset. When a 0.2-inch DMD chip is used, referring to FIG. 2, a dimension a of a long side of the DMD chip 7 is 4.616 mm, and a dimension b of a short side is 2.592 mm. In the case that the optical axis offset is 0, an imaging range of field of view is Y1, and a range of field of view is represented by a circle in FIG. 2. In this case, a center of the range of field of view is a center point P1 of the DMD chip, a radius of the field of view is r1, then the image height is 2*r1=^{2*}\sqrt{(4.616/2)²+(2.592/2)²}≈5.3. In the case that the optical axis offset is 100%, the imaging range of the field of view is Y2. In this case, the center of the range of field of view is P2, the radius of the field of view is r2 the image height is 2*r2=^{2*}\sqrt{(4.616/2)²+2.592²}≈6.94. It can be seen that the lens image height of the projection lens is 7.2 mm, which may allow the projection lens achieve the optical axis offset of 100%.

In some embodiments, the projection lens has a total length of 44 mm, the projection lens has an effective focal length of 5.7 mm, the projection lens has an F-number of 1.7, and the projection lens has a throw ratio of 1.2. The total length of the projection lens is the distance from a surface S1, proximal to an image side, of the first lens 1 to the DMD chip 7.

In some embodiments, the projection lens further includes a stop 8, wherein the stop 8 is disposed between the third lens 3 and the triple-cemented lens 4. By configuring the stop 8, a light aperture may be limited. A design should be such made that the light from the image side is allowed to pass through the stop 8 after passing through the third lens 3 and the light in the same field of view should be approximate parallel light.

In some embodiments, referring to FIG. 1, the first lens 1 is a first negative meniscus lens, wherein a convex surface S1 of the first negative meniscus lens is proximal to the image side, and a concave surface S2 of the first negative meniscus lens is proximal to the object side; and the first lens 1 has a focal length f1 satisfying −18 mm≤f1≤−16 mm.

In some embodiments, referring to FIG. 1, the second lens 2 is a second negative meniscus lens, wherein a convex surface S3 of the second negative meniscus lens is proximal to the image side, and a concave surface S4 of the second negative meniscus lens is proximal to the object side; and the second lens 2 has a focal length f2 satisfying −15 mm≤f2≤−13 mm.

In some embodiments, the third lens 3 is a planoconvex lens or a first biconvex lens, wherein a convex surface S5 of the planoconvex lens is proximal to the image side; and the third lens 3 has a focal length f3 satisfying 9 mm≤f3≤11 mm.

In some embodiments, the triple-cemented lens 4 is constructed by cementing a first negative lens 41, a second negative lens 42, and a second biconvex lens 43 successively from the image side to the object side, wherein the first negative lens 41 has a focal length f4 satisfying −12 mm≤f4≤−10 mm, the second negative lens 42 has a focal length f5 satisfying −11 mm≤f5≤−9.5 mm, and the second biconvex lens 43 has a focal length f6 satisfying 9 mm≤f6≤11 mm. The negative lenses are biconcave, plano-concave or convex-concave lenses.

In some embodiments, the fourth lens 5 is a third biconvex lens, and the fourth lens 5 has a focal length f7 satisfying 9.8 mm≤f7≤10 mm.

In some embodiments, the first lens 1 has a thickness d1 satisfying 1.2 mm≤d1≤1.5 mm; the second lens 2 has a thickness d2 satisfying 1.1 mm≤d2≤1.4 mm; the third lens 3 has a thickness d3 satisfying 2 mm≤d3≤2.5 mm; the first negative lens 41 has a thickness d4 satisfying 2.6 mm≤d4≤2.8 mm; the second negative lens 42 has a thickness d5 satisfying 0.9 mm≤d5≤1.1 mm; the second biconvex lens 43 has a thickness d6 satisfying 4 mm≤d6≤5 mm; and the fourth lens 5 has a thickness d7 satisfying 3.5 mm≤d7≤4.2 mm.

In some embodiments, a distance x1 between a surface S2, proximal to the object side, of the first lens 1 and a surface S3, proximal to the image side, of the second lens 2 satisfies 2.7 mm≤x1≤3 mm; and a distance x2 between a surface S4, proximal to the object side, of the second lens 2 and a surface S5, proximal to the image side, of the third lens 3 satisfies 3.7 mm≤x2≤4 mm; a distance x3 between a surface S6, proximal to the object side, of the third lens 3 and the stop 8 satisfies 2.1 mm≤x3≤3.3 mm; and a distance between the stop 8 and a surface S7, proximal to the image side, of the first biconvex lens is 0.59 mm; a distance x4 between a surface S20, proximal to the object side, of the second biconvex lens 43 and a surface S11, proximal to the image side, of the fourth lens 5 satisfies 0.1 mm≤x4≤0.2 mm; and a distance between a surface S12, proximal to the object side, of the fourth lens 5 and a surface S13, proximal to the image side, of the prism 6 is 4.27 mm.

In some embodiments, the first lens 1, the third lens 3, the first negative lens 41, the second negative lens 42, and the second biconvex lens 43 are spheric lenses, and the second lens 2 and the fourth lens 5 are aspheric lenses. Specifically, the second lens 2 may use a plastic aspheric surface, and the fourth lens 5 may use a glass aspheric surface. By using the glass aspheric surface and the plastic aspheric surface, impacts of the lens monochromatic aberration and chromatic aberration on projection images may be reduced, and the display effect of the projection lens may be improved.

In some embodiments, referring to FIG. 1, the projection lens further includes a protective glass 9, wherein the protective glass 9 is disposed between the prism 6 and the DMD chip 7. The protective glass 9 is configured to protect the DMD chip 7.

The optical performance of the projection lens according to the embodiments of the present disclosure is described in detail below with reference to specific design parameters.

Surface parameters of each lens of the projection lens are listed in Table 1 below.

TABLE 1
Surface parameters of each lens in the projection lens

| | Surface | Radius of | Thickness/ | |
|---|---|---|---|---|
| | No. | curvature/mm | mm | Material |
| First lens 1 | S1 | 14.0 | 1.50 | H-K9L |
| | S2 | 5 | 2.80 | |
| Second lens 2 | S3 | 100 | | E48R |
| | S4 | 7.2 | 3.82 | |
| Third lens 3 | S5 | 9 | 2.33 | H-QK3L |
| | S6 | −199 | 3.18 | |
| Stop 8 | Stop | Infinite | 0.59 | |
| Triple-cemented | S7 | −15 | 2.77 | H-K9L |
| lens 4 | | | | |
| | S8 | −4 | 1.00 | H-ZLAF76 |
| | S9 | 18 | 4.50 | H-ZPK7 |
| | S10 | −10 | 0.10 | |
| Fourth lens 5 | S11 | 11 | 4.00 | D-K9 |
| | S12 | −10 | 4.27 | |
| Prism 6 | S13 | Infinite | 10.00 | H-ZF3 |
| | S14 | Infinite | 0.72 | |
| Protective | S15 | Infinite | 0.65 | H-K9L |
| glass 9 | | | | |
| | S16 | Infinite | 0.30 | |

Based on the above structure, the effective focal length of the projection lens is 5.7 mm, the total length of the projection lens is 44 mm, the F-number of the projection lens is 1.7, the throw ratio of the projection lens is 1.2, and the lens image height is 7.2 mm. The projection lens with these parameters achieves the optical axis offset of 100%, is applicable to 0.2-inch DMD chip 7, and reduces the size of the projection lens. The projection lens may perform imaging at a distance of 0.5 m to 3 m, a relative illuminance is greater than 60%, and the imaging is better. In addition, the back focal length of the projection lens is 4.27 mm AIR+10 mm H-Lak7A+0.719 mm Air+0.65 mm H-K9L+0.303 mm Air. It is apparent that the back focal length of the projection lens is relatively long, which may provide an accommodation space for the prism 6.

An imaging quality of the above projection lens is tested hereinafter.

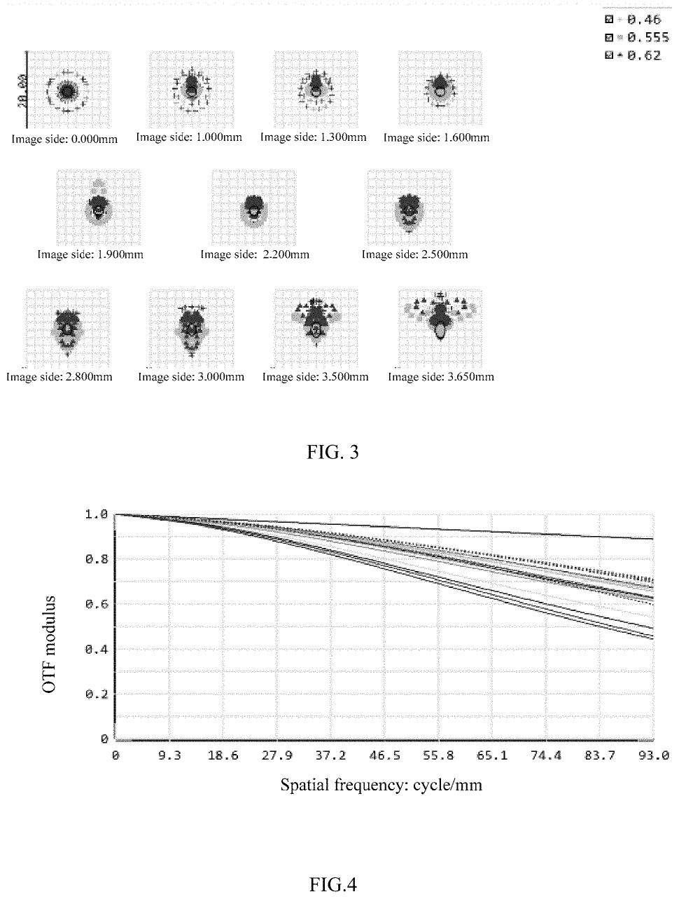

FIG. 3 is a spot diagram of the projection lens illustrated in FIG. 1. The spot diagram reflects a geometric structure of the imaging of an optical system. In the image quality evaluation, the density of the spot diagram may be used to reflect and measure an imaging quality of the system more visually. The smaller the RMS radius of the spot diagram, the smaller the aberration and the better the imaging quality of the system. As illustrated in FIG. 3, the RMS radius is controlled within 5.4 μm, that is, a spot size of each field of view in the projection lens is less than one pixel. The spot of each field of view is small, the aberration correction is better, and the imaging quality of the projection lens is good.

FIG. 4 is a modulation transfer function (MTF) curve diagram of the projection lens illustrated in FIG. 1. The MTF may comprehensively reflect an imaging quality of an optical system. The smoother the curve and the higher the height relative to the X axis, the better the imaging quality of the system. It can be seen from FIG. 4 that the MTF curve is relatively smooth, and an overall MTF of the projection lens is greater than 0.4. It can be seen that the projection lens achieves a good imaging effect, that is, the aberration of the projection lens in this embodiment is well corrected, and the imaging quality is excellent.

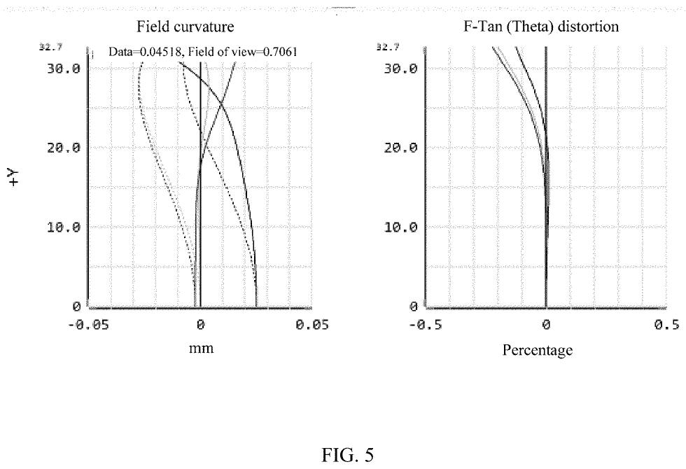

FIG. 5 is a field curvature and distortion diagram of the projection lens illustrated in FIG. 1, wherein a left side is a field curvature curve, and a right side is a distortion curve. Field curvature is an aberration when an object plane forms a curved image, and is characterized by a meridional field curvature and a sagittal field curvature. Greater meridional field curvature and sagittal field curvature will seriously affect the imaging quality of off-axis light of the optical system. It can be seen from FIG. 4 that the field curvature of the projection lens is corrected to a smaller range. Meanwhile, when the distortion of the system is less than 4%, it is difficult for human eyes to perceive the distortion. It can be seen from FIG. 4 that a maximum distortion of the projection lens is less than 1%, that is, the field curvature and distortion of the projection lens in this embodiment are small, and the imaging effect is good.

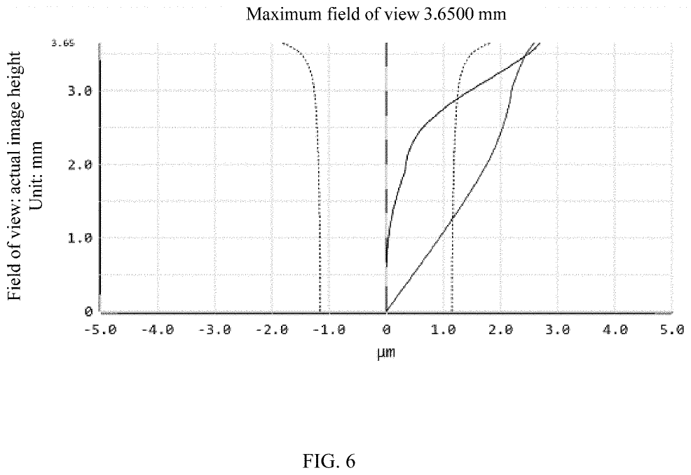

FIG. 6 is a vertical chromatic aberration diagram as illustrated in FIG. 1. It can be seen from FIG. 6 that the vertical chromatic aberration of the projection lens is less than one pixel.

It can be seen from the above data that the projection lens has a simple structure and a small size, is applicable to the small-dimension DMD chip 7, and has good aberration correction and excellent imaging quality.

In a second aspect, an embodiment of the present disclosure further provides a projector. The projector includes the projection lens according to the first aspect. The projection lens of the projector has a small size, and is applicable to small-dimension projection chips.

The embodiments of the present disclosure provide a projection lens and a projector. The projection lens includes: a first lens, a second lens, a third lens, a triple-cemented lens, a fourth lens, a prism, and a DMD chip that are successively disposed along an optical axis from an image side to an object side; wherein the first lens has a negative focal power, the second lens has a negative focal power, the third lens has a positive focal power, the triple-cemented lens has a positive focal power, and the fourth lens has a positive focal power. The projection lens has a small size, and is applicable to small-dimension projection chips.

It should be noted that the above described device embodiments are merely for illustration purpose only. The units which are described as separate components may be physically separated or may be not physically separated, and the components which are illustrated as units may be or may not be physical units, that is, the components may be deployed in the same position or may be distributed into a plurality of network units. Part or all of the modules may be selected according to the actual needs to achieve the objects of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A projection lens, comprising: a first lens, a second lens, a third lens, a triple-cemented lens, a fourth lens, a prism, and a DMD chip that are successively disposed along an optical axis from an image side to an object side;
wherein the first lens has a negative focal power, the second lens has a negative focal power, the third lens has a positive focal power, the triple-cemented lens has a positive focal power, and the fourth lens has a positive focal power.

2. The projection lens according to claim 1, wherein the DMD chip has a dimension of 0.2 inches.

3. The projection lens according to claim 1, wherein the projection lens has a total length of 44 mm, the projection lens has an effective focal length of 5.7 mm, the projection lens has an F-number of 1.7, and the projection lens has a throw ratio of 1.2.

4. The projection lens according to claim 3, further comprising a stop;
wherein the stop is disposed between the third lens and the triple-cemented lens.

5. The projection lens according to claim 1, wherein the first lens is a first negative meniscus lens, a convex surface of the first negative meniscus lens being proximal to the image side and a concave surface of the first negative meniscus lens being proximal to the object side; and the first lens has a focal length f1 satisfying −18 mm≤f1≤−16 mm; and
the second lens is a second negative meniscus lens, a convex surface of the second negative meniscus lens being proximal to the image side and a concave surface of the second negative meniscus lens being proximal to the object side; and the second lens has a focal length f2 satisfying −15 mm≤f2≤−13 mm;
the third lens is a planoconvex lens or a first biconvex lens, a convex surface of the planoconvex lens being proximal to the image side; and the third lens has a focal length f3 satisfying 9 mm≤f3≤11 mm;
the triple-cemented lens is constructed by cementing a first negative lens, a second negative lens, and a second biconvex lens, wherein the first negative lens has a focal length f4 satisfying −12 mm≤f4≤−10 mm, the second negative lens has a focal length f5 satisfying −11 mm≤f5≤−9.5 mm, and the second biconvex lens has a focal length f6 satisfying 9 mm≤f6≤11 mm; and
the fourth lens is a third biconvex lens, and the fourth lens has a focal length f7 satisfying 9.8 mm≤f7≤10 mm.

6. The projection lens according to claim 5, wherein the first lens has a thickness d1 satisfying 1.2 mm≤d1≤1.5 mm;
the second lens has a thickness d2 satisfying 1.1 mm≤d2≤1.4 mm;
the third lens has a thickness d3 satisfying 2 mm≤d3≤2.5 mm;
the first negative lens has a thickness d4 satisfying 2.6 mm≤d4≤2.8 mm;
the second negative lens has a thickness d5 satisfying 0.9 mm≤d5≤1.1 mm;
the second biconvex lens has a thickness d6 satisfying 4 mm≤d6≤5 mm; and
the fourth lens has a thickness d7 satisfying 3.5 mm≤d7≤4.2 mm.

7. The projection lens according to claim 6, wherein a distance x1 between a surface, proximal to the object side, of the first lens and a surface, proximal to the image side, of the second lens satisfies 2.7 mm≤x1≤3 mm; and
a distance x2 between a surface, proximal to the object side, of the second lens and a surface, proximal to the image side, of the third lens satisfies 3.7 mm≤x2≤4 mm;
a distance x3 between a surface, proximal to the object side, of the third lens and the stop satisfies 2.1 mm≤x3≤3.3 mm; and
a distance between the stop and a surface, proximal to the image side, of the first biconvex lens is 0.59 mm;
a distance x4 between a surface, proximal to the object side, of the second biconvex lens and a surface, proximal to the image side, of the fourth lens satisfies 0.1 mm≤x4≤0.2 mm; and
a distance between a surface, proximal to the object side, of the fourth lens and a surface, proximal to the image side, of the prism is 4.27 mm.

8. The projection lens according to claim 7, wherein the first lens, the third lens, the first negative lens, the second negative lens, and the second biconvex lens are spheric lenses, and the second lens and the fourth lens are aspheric lenses.

9. The projection lens according to claim 1, further comprising a protective glass;
wherein the protective glass is disposed between the prism and the DMD chip.

10. A projector, comprising: a first lens, a second lens, a third lens, a triple-cemented lens, a fourth lens, a prism, and a DMD chip that are successively disposed along an optical axis from an image side to an object side;
wherein the first lens has a negative focal power, the second lens has a negative focal power, the third lens has a positive focal power, the triple-cemented lens has a positive focal power, and the fourth lens has a positive focal power.

11. The projector according to claim 10, wherein the DMD chip has a dimension of 0.2 inches.

12. The projector according to claim 11, wherein the projection lens has a total length of 44 mm, the projection lens has an effective focal length of 5.7 mm, the projection lens has an F-number of 1.7, and the projection lens has a throw ratio of 1.2.

13. The projector according to claim 12, further comprising a stop;
wherein the stop is disposed between the third lens and the triple-cemented lens.

14. The projector according to claim 10, wherein the first lens is a first negative meniscus lens, a convex surface of the first negative meniscus lens being proximal to the image side and a concave surface of the first negative meniscus lens being proximal to the object side; and the first lens has a focal length f1 satisfying −18 mm≤f1 ≤−16 mm; and
the second lens is a second negative meniscus lens, a convex surface of the second negative meniscus lens being proximal to the image side and a concave surface of the second negative meniscus lens being proximal to the object side; and the second lens has a focal length f2 satisfying −15 mm≤f2≤−13 mm;
the third lens is a planoconvex lens or a first biconvex lens, a convex surface of the planoconvex lens being proximal to the image side; and the third lens has a focal length f3 satisfying 9 mm≤f3≤11 mm;
the triple-cemented lens is constructed by cementing a first negative lens, a second negative lens, and a second biconvex lens, wherein the first negative lens has a focal length f4 satisfying −12 mm≤f4≤−10 mm, the second negative lens has a focal length f5 satisfying −11 mm≤f5≤−9.5 mm, and the second biconvex lens has a focal length f6 satisfying 9 mm≤f6≤11 mm; and
the fourth lens is a third biconvex lens, and the fourth lens has a focal length f7 satisfying 9.8 mm≤f7≤10 mm.

15. The projector according to claim 14, wherein the first lens has a thickness d1 satisfying 1.2 mm≤d1≤1.5 mm;
the second lens has a thickness d2 satisfying 1.1 mm≤d2≤1.4 mm;
the third lens has a thickness d3 satisfying 2 mm≤d3≤2.5 mm;
the first negative lens has a thickness d4 satisfying 2.6 mm≤d4≤2.8 mm;
the second negative lens has a thickness d5 satisfying 0.9 mm≤d5≤1.1 mm;
the second biconvex lens has a thickness d6 satisfying 4 mm≤d6≤5 mm; and
the fourth lens has a thickness d7 satisfying 3.5 mm≤d7≤4.2 mm.

16. The projector according to claim 15, wherein a distance x1 between a surface, proximal to the object side, of the first lens and a surface, proximal to the image side, of the second lens satisfies 2.7 mm≤x1≤3 mm; and
a distance x2 between a surface, proximal to the object side, of the second lens and a surface, proximal to the image side, of the third lens satisfies 3.7 mm≤x2≤4 mm;
a distance x3 between a surface, proximal to the object side, of the third lens and the stop satisfies 2.1 mm≤x3≤3.3 mm; and
a distance between the stop and a surface, proximal to the image side, of the first biconvex lens is 0.59 mm;
a distance x4 between a surface, proximal to the object side, of the second biconvex lens and a surface, proximal to the image side, of the fourth lens satisfies 0.1 mm≤x4≤0.2 mm; and
a distance between a surface, proximal to the object side, of the fourth lens and a surface, proximal to the image side, of the prism is 4.27 mm.

17. The projector according to claim 16, wherein the first lens, the third lens, the first negative lens, the second negative lens, and the second biconvex lens are spheric lenses, and the second lens and the fourth lens are aspheric lenses.

18. The projector according to claim 10, further comprising a protective glass;
wherein the protective glass is disposed between the prism and the DMD chip.
